(19) United States
(12) Patent Application Publication
(10) Pub. No.: US 2025/0219299 A1
(43) Pub. Date: Jul. 3, 2025

(54) RADIO FREQUENCY FEED NETWORKS HAVING IMPEDANCE-MATCHING PATHS WITH DIFFERENT IMPEDANCES, AND RELATED METHODS OF OPERATING A BASE STATION ANTENNA

(71) Applicant: Outdoor Wireless Networks LLC, Claremont, NC (US)

(72) Inventors: Giuseppe Resnati, Seregno (IT); Alessandro Maurizio Delzanno, Sesto San Giovanni (IT); Corrado Scaccabarozzi, Milan (IT)

(21) Appl. No.: 18/850,178

(22) PCT Filed: May 26, 2023
(86) PCT No.: PCT/US2023/067529

§ 371 Date: Sep. 24, 2024

(30) Foreign Application Priority Data
Jun. 1, 2022 (IT) 102022000011603

(51) Int. Cl. H01Q 21/20; H01Q 1/24; H01Q 3/24; H01Q 19/10; H01Q 21/24

(52) U.S. Cl. CPC H01Q 21/205; H01Q 1/246; H01Q 3/247; H01Q 19/104; H01Q 21/24

(57) ABSTRACT

Radio frequency (RF) feed networks are provided. An RF feed network includes a plurality of impedance-matching paths that have different impedances. respectively. The impedance-matching paths are coupled between arrays of a base station antenna and an input of the RF feed network. Related methods of operating a base station antenna are also provided.

### FIELD

The present disclosure relates to communications systems and, in particular, to radio frequency (“RF”) feed networks that are usable, for example, with base station antennas.

### BACKGROUND

Cellular communications systems are well known in the art. In a cellular communications system, a geographic area is divided into a series of regions or “cells” that are served by respective base stations. Each base station may include one or more base station antennas that are configured to provide two-way RF communications with subscribers that are within the cell served by the base station. In many cases, each base station is divided into “sectors.” In one common configuration, a hexagonally-shaped cell is divided into three 120° sectors in the azimuth plane, and each sector is served by one or more base station antennas that generate outwardly-directed radiation patterns. For example, a base station antenna may generate an omnidirectional antenna pattern in the azimuth plane, meaning that the base station antenna may provide coverage extending through a full 360° circle in the azimuth plane.

Example base station antennas are discussed in International Publication No. WO 2017/165512 to Bisiules, U.S. patent application Ser. No. 15/921,694 to Bisiules et al., and U.S. patent application Ser. No. 63/024,846 to Hamdy et al., the disclosures of which are hereby incorporated herein by reference in their entireties. Base station antennas typically include one or more linear arrays or two-dimensional arrays of radiating elements, such as dipole, or crossed-dipole, radiating elements that act as individual antenna elements. An RF feed network may be used to pass RF signals between the arrays and one or more radios.

### SUMMARY

Pursuant to some embodiments of the present invention, base station antennas are provided that comprise a plurality of arrays of radiating elements and an RF feed network that has a plurality of impedance-matching paths that have different impedances, respectively. The impedance-matching paths are selectively coupled between the arrays and an input of the RF feed network.

In some embodiments, the impedance-matching paths may be coupled to a plurality of RF transmission lines, respectively, that are switchably coupled to ground by a plurality of switching elements, respectively, and each RF transmission line may have an electrical length of one-quarter of a wavelength corresponding to a center frequency of an operating frequency band of the arrays. In some embodiments, the RF transmission lines are respective stubs on a printed circuit board (PCB). In some embodiments, a first of the impedance-matching paths may comprise a first portion having a first line width on the PCB and a second portion having a second line width on the PCB that is different from the first line width, and a first of the stubs may be coupled to a node between the first and second portions of the first of the impedance-matching paths. In some embodiments, the second portion of the first of the impedance-matching paths may have a lower impedance than the first portion of the first of the impedance-matching paths, and may be coupled between the arrays and the first portion of the first of the impedance-matching paths.

In some embodiments, the base station antenna further may comprise a control circuit that is configured to select between the impedance-matching paths. In such embodiments, selecting between the impedance-matching paths may comprise selecting a first of the impedance-matching paths by closing a first of the switching elements and thereby short-circuiting to ground a first of the stubs that is coupled to the first of the impedance-matching paths. In some embodiments, the control circuit may be configured to close the first of the switching elements before opening a second of the switching elements that is short-circuiting to ground a second of the stubs that is coupled to a second of the impedance-matching paths.

In some embodiments, the base station antenna may further comprise a triangular reflector that has a plurality of faces that face in different directions, respectively, and the arrays of radiating elements may be on the respective faces of the reflector, and the impedance-matching paths may comprise three impedance-matching paths.

In some embodiments, the base station antenna may be configured to provide omnidirectional coverage in the azimuth plane.

In some embodiments, the input of the RF feed network may be a first input, and
the base station antenna may be provided in combination with a radio that includes first and second first-polarization RF ports that are coupled to the first input and a second input, respectively, of the RF feed network, and first and second second-polarization RF ports that are coupled to third and fourth inputs, respectively, of the RF feed network.

In some embodiments, the arrays may comprise six arrays of radiating elements, with three of the arrays coupled to the first and second ports of a radio, and the other three of the arrays coupled to third and fourth ports of the radio.

In some embodiments, the RF feed network may further comprise a plurality of array-selection paths that are coupled between the arrays and the impedance-matching paths, and the array-selection paths may be coupled to a plurality of RF transmission lines, respectively, that are switchably coupled to ground by a plurality of switching elements, respectively, and that each have an electrical length of one-quarter of a wavelength of an operating frequency of the arrays.

In some embodiments, the RF transmission lines may be respective stubs on a printed circuit board (PCB), and the base station antenna may further comprise a control circuit that is configured to short-circuit a first of the stubs to ground by closing a first of the switching elements, before opening a second of the switching elements that is short-circuiting a second of the stubs to ground.

Pursuant to further embodiments of the present invention, methods of operating a base station antenna are provided. Pursuant to these methods a stub on a printed circuit board (PCB) is short-circuited to ground by closing a switching element, while the PCB is coupled between a radio and a plurality of arrays of radiating elements of the base station antenna.

In some embodiments, the stub may comprise a first of a plurality of stubs on the PCB and the switching element may comprise a first of a plurality of switching elements, and the method may further comprise opening a second of the switching elements that is short-circuiting a second of the stubs to ground, after the closing of the first of the switching elements.

In some embodiments, the method further comprises, in an omnidirectional mode of the base station antenna, directing RF signals from the radio to three sectors of the base station antenna while the first of the switching elements is closed and the second of the switching elements and a third of the switching elements are open. In such embodiments, the first, second, and third of the switching elements may each be part of an impedance-matching portion of a radio frequency (RF) feed network, the impedance-matching portion of the RF feed network may comprise a plurality of impedance-matching paths that have different impedances, respectively, and are coupled between the three sectors and an RF port of the radio, and, in the omnidirectional mode, the RF signals may be directed to a first of the impedance-matching paths that has a lowest impedance among the impedance-matching paths.

In some embodiments, the closing of the first of the switching elements may be performed in response to selection of the omnidirectional mode.

In some embodiments, the stub may comprise a first of a plurality of stubs on the PCB and the switching element may comprise a first of a plurality of switching elements. In such embodiments, a second of the switching elements may be configured to short-circuit a second of the stubs to ground, a third of the switching elements may be configured to short-circuit a third of the stubs to ground, and the first, second, and third of the switching elements may each be part of an array-selection portion of an RF feed network.

In some embodiments, the method may further comprise, in an omnidirectional mode of the base station antenna, directing RF signals from a radio to three sectors of the base station antenna while the first, second, and third of the switching elements are each closed.

In some embodiments, the array-selection portion of the RF feed network may further comprise a fourth of the switching elements that is configured to short-circuit a fourth of the stubs to ground, and the method may further comprise, in an omnidirectional mode of the base station antenna, directing RF signals from a radio to four sectors of the base station antenna while the first, second, third, and fourth of the switching elements are each closed.

Pursuant to still further embodiments of the present invention, base station antennas are provided that comprise an RF port, a plurality of arrays of radiating elements that are coupled to the RF port, and an RF feed network that is coupled between the RF port and the arrays. The RF feed network comprises an impedance-matching portion including at least three impedance-matching paths that have different impedances, respectively, and are coupled between the arrays and the RF port, and an array-selection portion including at least three paths that are coupled between the arrays and the impedance-matching portion.

In some embodiments, the impedance-matching portion may further include a plurality of stubs on a PCB that are coupled to the impedance-matching paths, respectively.

In some embodiments, the base station antenna may further comprise a plurality of switching elements that are coupled between the stubs, respectively, and ground.

In some embodiments, the base station antenna may further comprise a single rotary switch that is coupled between all of the stubs and ground.

In some embodiments, the stubs may each have an electrical length of one-quarter of a wavelength of an operating frequency of the arrays.

In some embodiments, a first of the impedance-matching paths may comprise a first portion having a first line width on the PCB and a second portion having a second line width on the PCB that is wider than the first line width, and a first of the stubs may be coupled to a node between the first and second portions of the first of the impedance-matching paths.

In some embodiments, the array-selection portion may further include a plurality of stubs on a PCB that are coupled to the at least three paths, respectively.

In some embodiments, the base station antenna may further comprise a plurality of switching elements that are coupled between the stubs, respectively, and ground.

In some embodiments, the stubs may each have an electrical length of one-quarter of a wavelength of an operating frequency of the arrays.

### BRIEF DESCRIPTION OF THE DRAWINGS

FIG. 1A is a top view of a base station antenna, according to embodiments of the present invention.

FIG. 1B is a schematic block diagram of ports of the base station antenna of FIG. 1A electrically connected to ports of a radio.

FIG. 2A is a schematic block diagram of the feed network of FIG. 1B.

FIG. 2B is a schematic block diagram of a printed circuit board (“PCB”) comprising a first of the paths of the impedance-matching portion of FIG. 2A.

FIGS. 2C-2E are schematic circuit diagrams illustrating different states of the switching elements of FIG. 2A.

FIGS. 3A-3C are flowcharts illustrating operations of switching between the states shown in FIGS. 2C-2E.

FIG. 4 is a schematic block diagram of a feed network of a four-sector base station antenna, according to further embodiments of the present invention.

FIG. 5 is a schematic block diagram of a feed network having an array-selection portion that includes tiers of RF switching elements that do not couple a stub to ground, according to other embodiments of the present invention.

FIG. 6 is a schematic block diagram of a feed network having an impedance-matching portion that includes a rotary switch, according to further embodiments of the present invention.

### DETAILED DESCRIPTION

Pursuant to embodiments of the present invention, RF feed networks are provided that can efficiently direct RF energy from a radio to all sectors, or to one or more selected (but not all) sectors, of a multi-sector base station antenna. In conventional multi-sector antennas, the use of fewer than all sectors (i.e., directing RF energy to at least one sector while refraining from directing RF energy to at least one other sector) can result in significant power divider losses. Moreover, the selection of different sectors, or combinations thereof, may use a large number of switching elements, which complicate feed network circuitry/operations and can increase losses of RF energy.

According to embodiments of the present invention, however, RF feed networks can have simplified circuitry/operations and reduced RF losses by using a relatively small number of switching elements, while also being highly controllable by allowing for selection of any permutation of sectors. For example, an RF feed network may include a plurality of impedance-matching paths that have different impedances, respectively. Each impedance-matching path may be coupled to a respective quarter-wavelength (λ/4) RF transmission line stub that is switchably coupled to ground by a respective switching element, where the “wavelength” refers to the wavelength corresponding to a center frequency of an operating frequency band for the arrays of radiating elements that are fed by the RF feed network. As an example, the impedance-matching path may be on a PCB, and a λ/4 RF transmission line stub may be coupled to the impedance-matching path. The switching element may be coupled between the λ/4 stub and ground. Compared with conventional feed network paths that are populated with multiple switching elements, feed network paths according to embodiments of the present invention that are switchably coupled to respective λ/4 stubs to ground by respective switching elements can provide more control of electrical length and can operate with smaller switching losses.

Example embodiments of the present invention will be described in greater detail with reference to the attached figures.

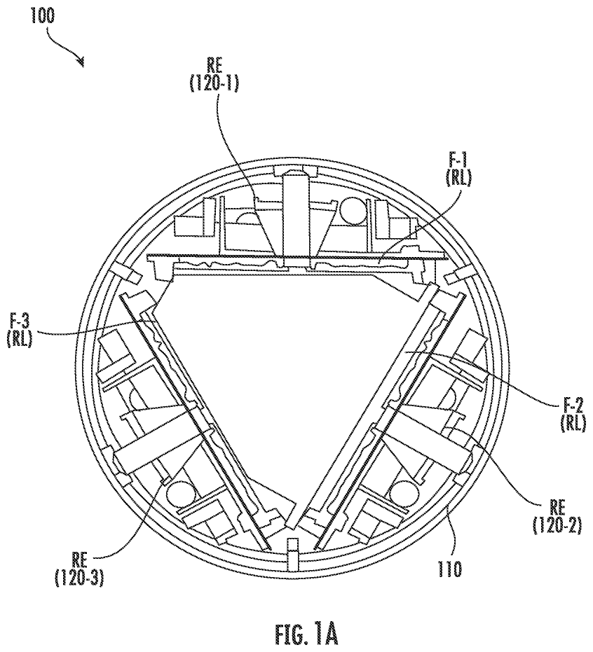

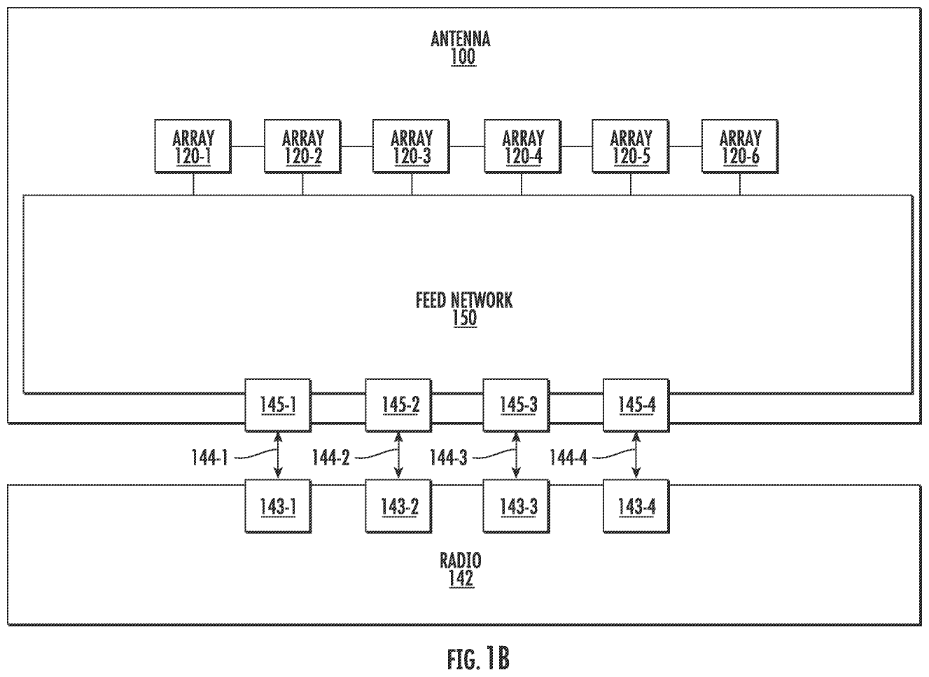

FIG. 1A is a top view of a multi-sector base station antenna 100, according to embodiments of the present invention. The antenna 100 may be, for example, a cellular base station antenna at a macrocell base station or at a small cell base station. The antenna 100 includes a radome 110. In some embodiments, the antenna 100 further includes a top end cap and/or a bottom end cap. For simplicity of illustration, the top end cap is omitted from view in FIG. 1A. The bottom end cap may include a plurality of RF connectors 145 (FIG. 1B) mounted therein. The connectors 145, which may also be referred to herein as “ports,” are not limited, however, to being located on the bottom end cap. The antenna 100 is typically mounted in a vertical configuration (i.e., the long side of the antenna 100 extends along a vertical axis with respect to Earth).

The antenna 100 includes a reflector assembly RL having a triangular cross-section, and six arrays 120-1 through 120-6 of radiating elements RE mounted on three faces F-1 through F-3, respectively, of the reflector assembly RL. Two arrays 120 are vertically stacked on each face, with arrays 120-1 and 120-2 vertically stacked on face F-1, arrays 120-3 and 120-4 vertically stacked on face F-2, and arrays 120-5 and 120-6 vertically stacked on face F-3. The radiating elements RE are mounted to extend outwardly from the faces F and such that each array 120 is oriented generally vertically with respect to the horizon when the antenna 100 is mounted for use. Each face F may act as a reflector and as a ground plane for the radiating elements RE mounted thereon.

The radiating elements RE may have various shapes and/or structures. For example, the radiating elements RE may be sheet-metal radiating elements that may be implemented with various shapes and/or feeding techniques. In some embodiments, the radiating elements RE may be patch radiating elements or crossed-dipole radiating elements.

Though the reflector assembly RL is shown in FIG. 1A as having three faces F-1 through F-3, the reflector assembly RL may, in other embodiments, have additional faces F, such as a total of four faces F that have respective arrays 120 mounted thereon. Accordingly, the antenna 100 may be implemented as a four-sector antenna rather than the tri-sector antenna that is shown in FIG. 1A. The reflector assembly RL may thus have a non-triangular cross-section, such as a rectangular cross-section.

FIG. 1B is a schematic block diagram of the base station antenna 100 showing its connections to respective ports 143 of a radio 142. For example, the radio 142 may be a cellular base station radio, such as a remote radio head, and the antenna 100 and the radio 142 may be located at (e.g., may be components of) a cellular base station. In some embodiments, the radio 142 may be mounted below the antenna 100. As shown in FIG. 1B, ports 145-1 through 145-4 of the antenna 100 are electrically connected to ports 143-1 through 143-4, respectively, of the radio 142 by respective RF transmission lines 144-1 through 144-4, such as coaxial cables. The ports 145-1 through 145-4 of the antenna 100 are electrically coupled to six arrays of radiating elements 120-1 through 120-6 through an RF feed network 150.

In some embodiments, the radio 142 may be a four-port radio configured to operate using a time division duplex (“TDD”) communications scheme. The RF feed network 150 is coupled between the six arrays 120-1 through 120-6 and the radio 142. For example, the arrays 120 may be coupled to respective RF transmission paths (e.g., including one or more RF transmission lines) of the feed network 150. The RF feed network 150 may be configured to direct substantially all of the RF energy output by first and second radio ports 145-1, 145-2 (one for each of two polarizations) to a selected one or more of the three arrays 120-1 through 120-3 during selected time slots in a frame structure of the TDD communications scheme. For example, during a given time slot, RF feed network 150 may direct substantially all of the RF energy output by the first radio port 145-1 to array 120-1, to array 120-2, to array 120-3, to arrays 120-1 and 120-2, to arrays 120-2 and 120-3, to arrays 120-1 and 120-3, or to all three of arrays 120-1 through 120-3, depending upon the desired antenna pattern for the time slot. The RF feed network 150 is likewise configured to direct substantially all of the RF energy output by the second radio port 145-2 to array 120-1, to array 120-2, to array 120-3, to arrays 120-1 and 120-2, to arrays 120-2 and 120-3, to arrays 120-1 and 120-3, or to all three of arrays 120-1 through 120-3, depending upon the desired antenna pattern for the time slot. Similarly, the RF feed network 150 is configured to direct substantially all of the RF energy output by third and fourth radio ports 145-3, 145-4 (one for each of two polarizations) to a selected one or more of the three arrays 120-4 through 120-6 during selected time slots in a frame structure of the TDD communications scheme. According to some embodiments, the ports 145-1 and 145-2 may be first-polarization ports (and the ports 145-3 and 145-4 may be second-polarization ports).

As discussed above, in some embodiments, the six arrays 120-1 through 120-6 may be arranged as three pairs of vertically-stacked arrays of radiating elements RE. In other embodiments, the six arrays 120-1 through 120-6 may be arranged so that two arrays 120 are provided side-by-side on each of the three faces F-1 through F-3 of the reflector assembly RL. It will also be appreciated that more or less than six arrays 120 may be included in the antenna 100. For example, a total of three arrays 120 could be provided in other embodiments, with a single array 120 per face F of the reflector assembly RL. Such embodiments would typically be coupled to a two port radio 142. In other embodiments, more than two arrays 120 could be provided per face F of the reflector assembly RL, and the radio 142 could include more than four ports 143.

Radiating elements RE of the six arrays 120-1 through 120-6 may transmit and/or receive RF signals in one or more frequency bands, such as one or more bands comprising frequencies between 3.3 gigahertz (“GHz”) and 4.2 GHz. For example, the radiating elements RE may, in some embodiments, transmit and/or receive RF signals at 3.5 (or 3.85) GHz in a TDD communications scheme.

The arrays 120 may each include a plurality of radiating elements RE that are spaced apart from each other in a vertical direction so that each array 120 extends in the vertical direction. As discussed above, two arrays 120 may be vertically-stacked on each face F of the reflector assembly RL, so that together each pair of vertically-stacked arrays 120 extend from a lower portion of an antenna assembly of antenna 100 to an upper portion of the antenna assembly. The vertical direction may be, or may be parallel with, a longitudinal axis that is perpendicular to the horizon. As used herein, the term “vertical” does not necessarily require that something is exactly vertical (e.g., the antenna 100 may have a small mechanical down-tilt). The number of radiating elements RE in an array 120 can be any quantity from two to twenty or more. In some embodiments, the arrays 120 may each have the same number (e.g., eight) of radiating elements RE.

According to some embodiments, the radiating elements RE are dual-polarized and each array 120 is coupled to a single port 145 per polarization. For example, the arrays 120-1, 120-2, and 120-3 may each be coupled to the first-polarization port 145-1 and the second-polarization port 145-2. The arrays 120-4, 120-5, and 120-6 may each be coupled to the first-polarization port 145-3 and the second-polarization port 145-4. Accordingly, each array 120 is coupled to two of the ports 145-1 through 145-4.

Moreover, the antenna 100 may include phase shifters that are used to electronically adjust the tilt angles of radiation patterns generated by the arrays 120. The phase shifters may be located at any appropriate location along the RF transmission paths that extend between the ports 145 and the arrays 120. Accordingly, though omitted from view in FIG. 1B for simplicity of illustration, the feed network 150 may include phase shifters.

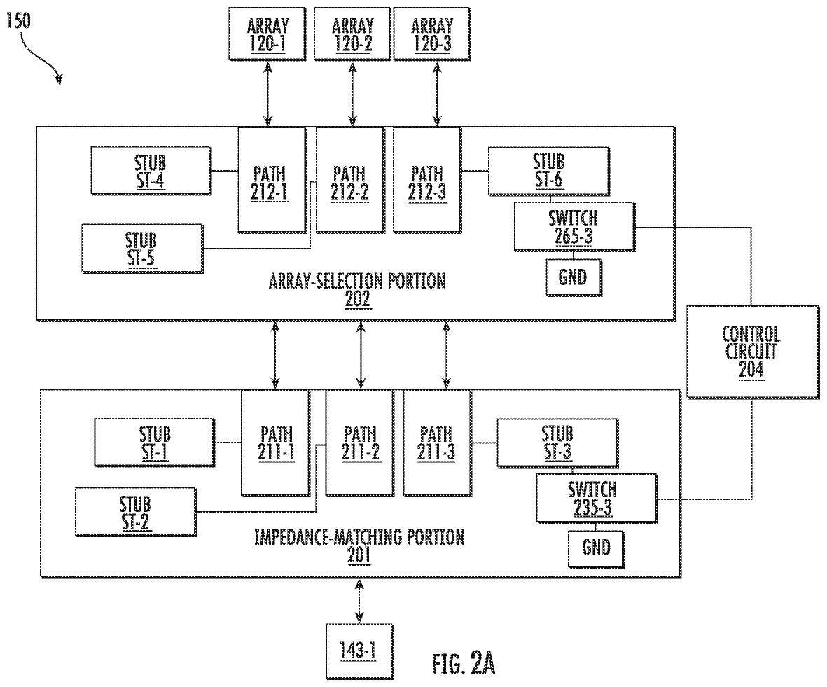

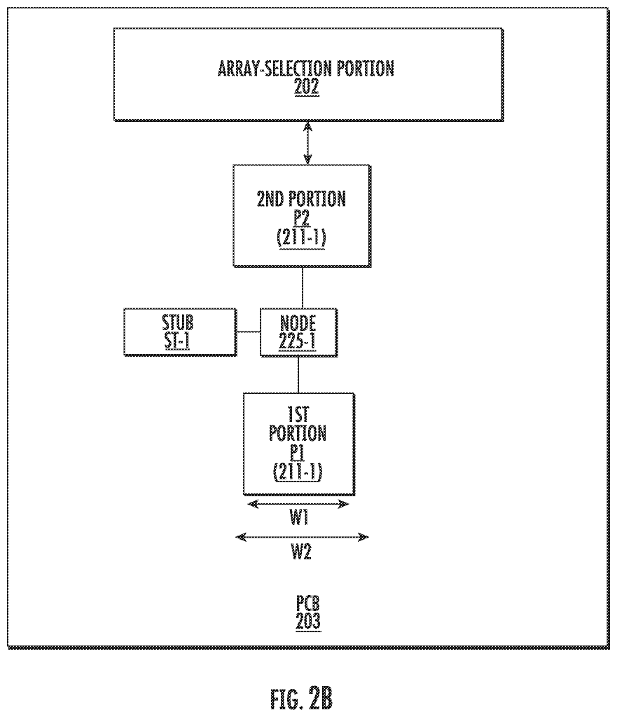

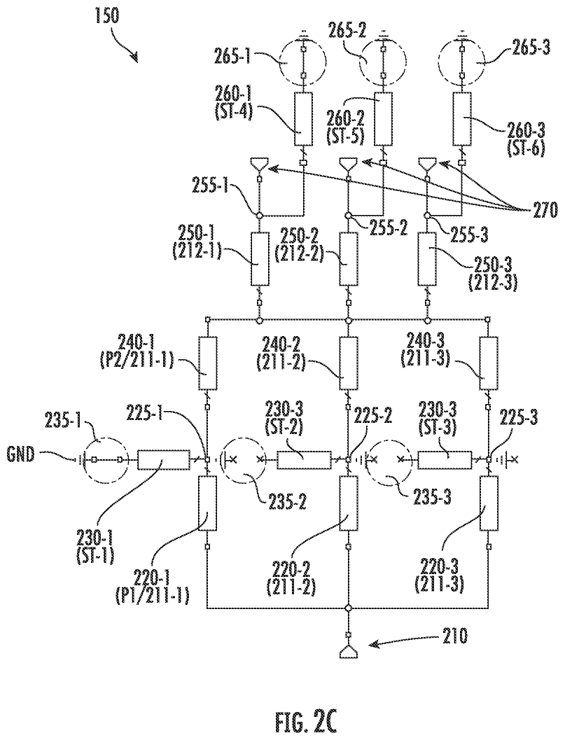

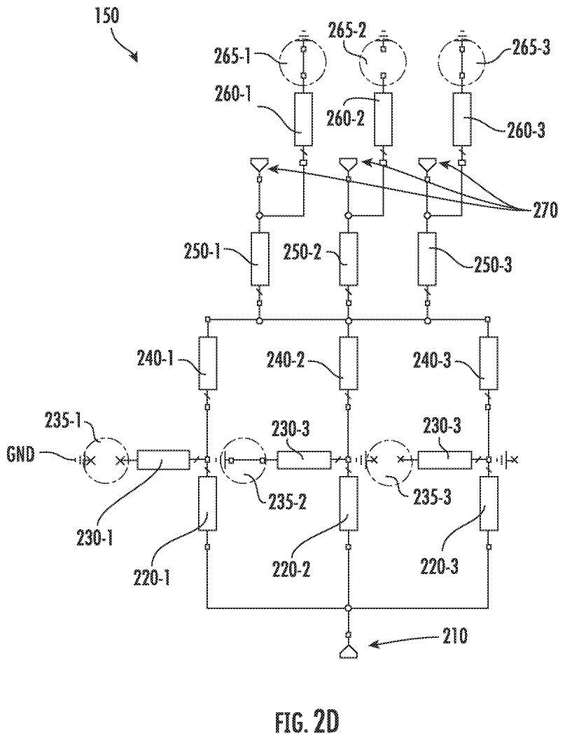

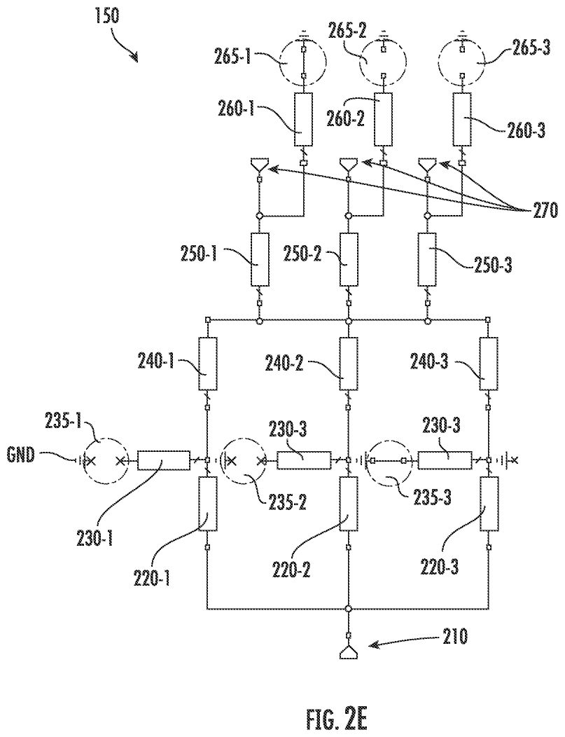

FIG. 2A is a schematic block diagram of one portion of the feed network 150 of FIG. 1B that shows the connections between a first of the radio ports 143-1 and the three arrays 120-1 through 120-3 that are fed by the first radio port 143-1. The other three portions of the feed network that connect the second radio port 143-2 to arrays 120-1 through 120-3 and that connect the third and fourth radio ports 143-3, 143-4 to arrays 120-4 through 120-6 may be identical to the first portion of the feed network shown in FIG. 2A. As shown in FIG. 2A, each portion of the feed network 150 includes an impedance-matching portion 201 and an array-selection portion 202. The array-selection portion 202 is coupled between the impedance-matching portion 201 and the three arrays 120-1 through 120-3. Moreover, the impedance-matching portion 201 is coupled between the array-selection portion 202 and the first port 143-1 of the radio 142. In some embodiments, a first port 145-1 (FIG. 1B) of the base station antenna 100 (FIG. 1B) may be coupled between the first port 143-1 and the impedance-matching portion 201.

For simplicity of illustration, FIG. 2A shows RF paths (of the impedance-matching portion 201 and the array-selection portion 202) between the three arrays 120-1 through 120-3 and the first port 143-1.

The impedance-matching portion 201 includes three RF paths 211-1 through 211-3 (also referred to herein as “impedance-matching paths”) that are coupled between the first port 143-1 and the array-selection portion 202. Each path 211 is coupled to a respective RF transmission line that is switchably coupled to ground GND. For example, FIG. 2A illustrates three RF transmission lines that are implemented as three λ/4 stubs ST-1 through ST-3, respectively, that are switchably coupled to ground GND. As shown in FIG. 2A, a third RF switching element 235-3 is coupled between the third stub ST-3 and ground GND.

For simplicity of illustration, first and second switching elements 235-1 and 235-2 (FIG. 2C) that couple the first and second stubs ST-1 and ST-2, respectively, to ground GND are omitted from view in FIG. 2A. Each switching element 235 may comprise a mechanical or solid-state relay. As an example, each switching element 235 may be a micromechanical relay or a PIN diode switch.

The array-selection portion 202 includes three RF paths 212-1 through 212-3 that are coupled between the three arrays 120-1 through 120-3, respectively, and the impedance-matching portion 201. Each path 212 is coupled to a respective RF transmission line that is switchably coupled to ground GND. For example, FIG. 2A illustrates three RF transmission lines that are implemented as three λ/4 stubs ST-4 through ST-6, respectively, that are switchably coupled to ground GND. As shown in FIG. 2A, a third RF switching element 265-3 is coupled between the sixth stub ST-6 and ground GND. For simplicity of illustration, first and second switching elements 265-1 and 265-2 (FIG. 2C) that couple the fourth and fifth stubs ST-4 and ST-5, respectively, to ground GND are omitted from view in FIG. 2A. The switching elements 265 may comprise mechanical or solid-state relays, such as micromechanical relays or PIN diode switches.

In some embodiments, the antenna 100 may include a control circuit 204 that is configured to control the three switching elements 235 of the impedance-matching portion 201 and the three switching elements 265 of the array-selection portion 202. In other embodiments, the switching elements 235 may be controlled by a control circuit 204 different from that which controls the switching elements 265. When a switching element 235 (or a switching element 265) is closed so that the 24 stub is short-circuited to ground GND, the stub ST becomes transparent and RF energy can flow though the path 211 (or a path 212) that is coupled to the stub ST. On the other hand, when a switching element 235 (or switching element 265) is opened, the λ/4 stub ST is disconnected from ground GND, and therefore acts to reflect RF energy from proceeding through the path 211 (or the path 212) and redirecting it to one or more other paths 211 (or one or more other paths 212).

FIG. 2B is a schematic block diagram of a printed circuit board (“PCB”) 203 comprising a first path 211-1 of the impedance-matching portion 201 of FIG. 2A. The path 211-1 includes a first portion Pl and a second portion P2 that is coupled between the array-selection portion 202 and the first portion P1. The first stub ST-1 is coupled to a first node 225-1 that is coupled between the first and second portions P1, P2.

In some embodiments, the first and second portions P1, P2 may comprise metal (e.g., copper) traces having different first and second line widths W1, W2, respectively, on the PCB 203. For example, the second line width W2 may be wider than the first line width W1, and thus may provide the second portion P2 with a lower impedance than the first portion P1. As an example, the first and second portions P1, P2 may be first and second RF transmission lines, respectively, that have impedances of 50 ohms and 28.8 ohms, respectively. Techniques other than adjusting the line widths may alternatively be used to adjust the impedances of the first and second portions, as is known in the art.

For simplicity of illustration, the second and third paths 211-2, 211-3 of the impedance-matching portion 201 are omitted from view in FIG. 2B. Like the first path 211-1, however, the second and third paths 211-2, 211-3 may each have first and second portions P1, P2 (e.g., first and second RF transmission lines) and a node 225 that is coupled between the first and second portions P1, P2 (and coupled to a stub ST) on the PCB 203. Moreover, though each stub ST is switchably coupled to ground GND (FIG. 2A), switching elements 235 (FIG. 2A) and ground GND are omitted from view in FIG. 2B for simplicity of illustration. In some embodiments, ground GND may be provided by a ground plane on the rear surface of the PCB 203. The ground plane may comprise, for example, copper.

FIGS. 2C-2E are schematic circuit diagrams illustrating different states of the switching elements 235, 265 of FIG. 2A. As shown in FIG. 2C, the three switching elements 265-1 through 265-3 are all closed. As a result, the feed network 150 directs RF energy from an RF input port 210 of the feed network 150 to three RF output ports 270 of the feed network 150. The input port 210 may be, or may be coupled to, the first port 145-1 (FIG. 1B) of the antenna 100 (FIG. 1B). The three output ports 270 are coupled to the first through third arrays 120-1 through 120-3 (FIG. 2A), respectively. As RF energy is directed to all three arrays 120-1 through 120-3 when the three switching elements 265-1 through 265-3 are closed, FIG. 2C illustrates an omnidirectional configuration/state of the feed network 150.

For simplicity of illustration, connections in FIGS. 2C-2E are shown with respect to the single input port 210. Analogous connections, however, may be provided between three additional input ports 210 (which may be, or may be coupled to, the second through fourth ports 145-2 through 145-4 of the antenna 100) and three sets of three additional output ports 270 that are coupled to the arrays 120. The feed network 150 may thus include four instances of the circuitry shown in FIGS. 2C-2E coupled between the four ports 143-1 through 143-4 (FIG. 1B), respectively, of the radio 142 (FIG. 1B) and the six arrays 120-1 through 120-6. Accordingly, each port 143 of the radio 142 may be coupled to a respective input port 210 of the feed network 150, and the first through third arrays 120-1 through 120-3 may be coupled to two sets of three output ports 270, fourth through sixth arrays 120-4 through 120-6 may be coupled to another two sets of three output ports 270. Each set of three output ports 270 is coupled to a respective input port 210 via three paths 211 of the impedance-matching portion 201 (FIG. 2A) of the feed network 150 and three paths 212 of the array-selection portion 202 (FIG. 2A) of the feed network 150.

The three paths 211-1 through 211-3 of the impedance-matching portion 201 include first RF transmission lines 220-1 through 220-3 (first portions P1 of the paths 211), respectively, and second RF transmission lines 240-1 through 240-3 (second portions P2 of the paths 211), respectively. Three nodes 225-1 through 225-3 are coupled between the first transmission lines 220-1 through 220-3, respectively, and the second RF transmission lines 240-1 through 240-3, respectively.

In some embodiments, each first transmission line 220 may have the same impedance (e.g., 50 ohms), and each second transmission line 240 may have a different impedance. For example, the transmission line 240-2 may have an impedance that is larger than an impedance of the transmission line 240-1 and smaller than an impedance of the transmission line 240-3. As an example, the transmission lines 240-1 through 240-3 may have impedances of 28.86 ohms, 35.36 ohms, and 50 ohms, respectively. Accordingly, an impedance transformation (e.g., an impedance stepdown) may occur from the transmission line 220-1 to the transmission line 240-1, and from the transmission line 220-2 to the transmission line 240-2. Moreover, the transmission lines 220 and 240 may all have the same electrical length, such as 90 degrees (i.e., one-quarter of a wavelength of center frequency of an operating frequency band of the arrays 120).

The impedance-matching portion 201 of the feed network 150 also includes third RF transmission lines 230-1 through 230-3 that are coupled to the nodes 225-1 through 225-3, respectively, of the paths 211-1 through 211-3, respectively. In some embodiments, the third transmission lines 230 may be implemented as stubs ST-1 through ST-3, respectively, on the PCB 203 (FIG. 2B) that are switchably coupled to ground GND by respective switching elements 235-1 through 235-3. Each third transmission line 230 (e.g., each stub ST) may have the same impedance, such as 50 ohms, and/or the same electrical length, such as 90 degrees (i.e., one-quarter of a wavelength of the center frequency of the operating frequency band of the arrays 120).

The three paths 212-1 through 212-3 of the array-selection portion 202 of the feed network 150 include fourth RF transmission lines 250-1 through 250-3, respectively, and three nodes 255-1 through 255-3, respectively, that are coupled between the fourth transmission lines 250-1 through 250-3, respectively, and the output ports 270. In some embodiments, the fourth transmission lines 250-1 through 250-3 may each have the same impedance (e.g., 50 ohms) and the same electrical length (e.g., 90 degrees).

The array-selection portion 202 of the feed network 150 also includes fifth RF transmission lines 260-1 through 260-3 that are switchably coupled between the nodes 255-1 through 255-3, respectively, of the paths 212-1 through 212-3, respectively, and ground GND by switching elements 265-1 through 265-3, respectively. In some embodiments, the fifth transmission lines 260-1 through 260-3 may be implemented as stubs ST-4 through ST-6, respectively, on the PCB 203. Each fifth transmission line 260 (e.g., stub ST) may have the same impedance (e.g., 50 ohms) and/or the same electrical length (e.g., 90 degrees).

In some embodiments, the state (e.g., open or closed) of each switching element 235 and 265 may be controlled by the control circuit 204 (FIG. 2A). For example, in the omnidirectional configuration that is shown in FIG. 2C, the control circuit 204 may be configured to select the first path 211-1 (among the three paths 211-1 through 211-3) by closing the first switching element 235-1 and thereby short-circuiting the first stub ST-1 to ground GND. In selecting between the three paths 211-1 through 211-3, the control circuit 204 may choose the first path 211-1 for operating the antenna 100 in an omnidirectional mode because the first path 211-1 may have an impedance that provides a proper impedance match for matching one of the paths 211 to all three arrays 120.

Unlike the first switching element 235-1, the second and third switching elements 235-2, 235-3 are open in the omnidirectional configuration that is shown in FIG. 2C. As a result, RF energy that might otherwise be directed to the arrays 120 via the second and third paths 211-2, 211-3 may instead be forced through the first path 211-1 to the arrays 120. In some embodiments, the control circuit 204 may be configured to control the closing of the first switching element 235-1 before opening either the second switching element 235-2 or the third switching element 235-3 (which are short-circuiting the stubs ST-2 and ST-3, respectively, to ground GND while operating in a closed state). Opening and closing the switching elements 235 in this order may reduce the likelihood of triggering a base station alarm (e.g., due to a full reflection resulting from all three switching elements 235-1 through 235-3 being open simultaneously).

The control circuit 204 may, likewise, be configured to close one of the switching elements 265 of the array-selection portion 202 before opening another one of the switching elements 265. As shown in FIG. 2C, the switching elements 265-1 through 265-3 short-circuit the stubs ST-4 through ST-6, respectively, of the array-selection portion 202 to ground GND in the omnidirectional configuration.

According to some embodiments, a power divider circuit (e.g., a microstrip power divider circuit on the PCB 203) may be coupled between the input port 210 and the three first transmission lines 220-1 through 220-3. Moreover, a phase shifter (e.g., on the PCB 203) may, in some embodiments, be coupled between a respective output port 270 and a respective array 120.

FIG. 2D shows a configuration in which RF energy is provided to two sectors (and not all three sectors) of the antenna 100 (FIG. 1B). This two-sector configuration may be achieved by closing the second switching element 235-2 of the impedance-matching portion 201 (FIG. 2A) of the feed network 150, which selects path 211-2. Path 211-2 has an impedance that provides a proper impedance match for matching one of the paths 211 to two of the three arrays 120. For example, to transition from the omnidirectional configuration to the two-sector configuration, the first switching element 235-1 that was short-circuiting the transmission line 230-1 to ground GND in the omnidirectional configuration may be opened after closing the second switching element 235-2. As another example, to transition from a single-sector configuration to the two-sector configuration, a switching element (e.g., the third switching element 235-3) that was short-circuiting the transmission line 230-3 to ground GND in the single-sector configuration may be opened after closing the second switching element 235-2.

In the array-selection portion 202 (FIG. 2A) of the feed network 150, FIG. 2D shows that the second switching element 265-2 may be opened, and the first and third switching elements 265-1 and 265-3 may be closed, to achieve the two-sector configuration. As a result, RF energy may be split evenly between the first and third arrays 120-1 and 120-3 (FIG. 2A) that are coupled to the transmission lines 250-1 and 250-3, respectively, of the paths 212-1 and 212-3 (FIG. 2A), respectively. In some embodiments, the opening and closing of switching elements 235 and 265 may be performed under the control of the control circuit 204 (FIG. 2A). It will be appreciated that alternatively the first switching element 265-2 may be opened, and the second and third switching elements 265-1 and 265-3 may be closed, of the third switching element 265-3 may be opened, and the first and second switching elements 265-1 and 265-2 may be closed to achieve other two-sector configurations.

FIG. 2E shows a configuration in which RF energy is provided to only one sector of the antenna 100 (FIG. 1B). This single-sector configuration may be achieved by closing the third switching element 235-3 of the impedance-matching portion 201 (FIG. 2A) of the feed network 150. For example, to transition from the two-sector configuration to the single-sector configuration, the second switching element 235-2 that was short-circuiting the transmission line 230-2 to ground GND in the two-sector configuration may be opened after closing the third switching element 235-3. As another example, to transition from the omnidirectional configuration to the single-sector configuration, the first switching element 235-1 that was short-circuiting the transmission line 230-1 to ground GND in the omnidirectional configuration may be opened after closing the third switching element 235-3. By closing the third switching element 235-3, the RF energy is routed through impedance path 211-3 (among the three paths 211-1 through 211-3), which has the highest impedance of the three paths 211. The impedance of path 211-3 may be set to match the impedance of a single one of the arrays 120.

In the array-selection portion 202 (FIG. 2A) of the feed network 150, FIG. 2E shows that the second and third switching elements 265-2 and 265-3 may be opened, and only the first switching element 265-1 may be closed, to achieve the single-sector configuration. In other examples of the single-sector configuration, only the second switching element 265-2 may be closed or only the third switching element 265-3 may be closed. Moreover, the opening and closing of switching elements 235 and 265 may be performed under the control of the control circuit 204 (FIG. 2A).

It will be appreciated that FIGS. 2C-2E illustrate operations for setting the connections of a first portion of the feed network 150 that selectively connects a first port 145-1 to the first through third arrays 120-1 through 120-3. A second portion of the feed network that may be identical to the first portion is used to selectively connects a second port 145-1 to the first through third arrays 120-1 through 120-3. The third and fourth portions of the feed network 150 may be identical to the first and second portions and are used to selectively connect third and fourth ports 145-3, 145-4 to the fourth through sixth arrays 120-4 through 120-6.

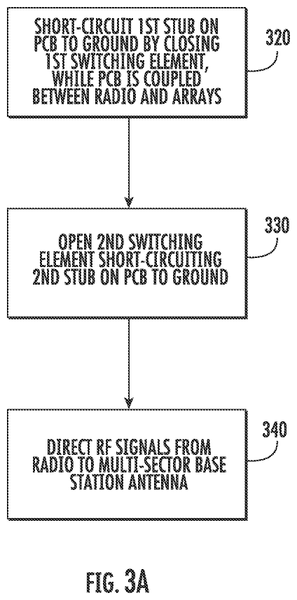

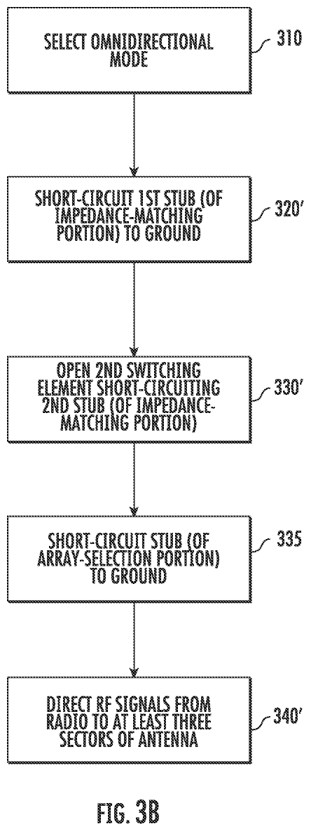

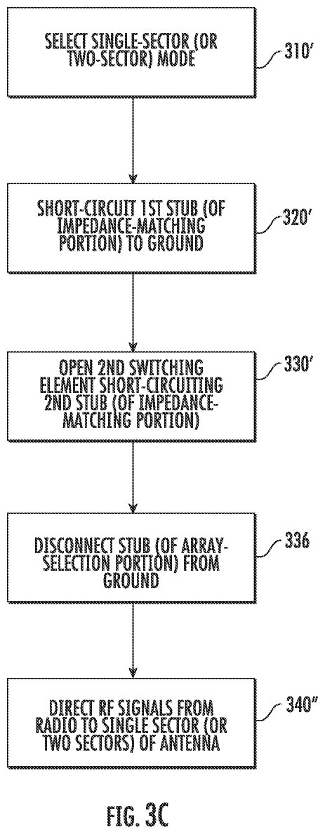

FIGS. 3A-3C are flowcharts illustrating operations of switching between the states shown in FIGS. 2C-2E. As shown in FIG. 3A, the operations include short-circuiting (Block 320) a stub ST (FIG. 2A) on a PCB 203 (FIG. 2B) to ground GND by closing a switching element 235 (FIGS. 2C-2E), and/or a switching element 265 (FIGS. 2C-2E), that is coupled between the stub ST and ground GND. The switching element 235 (and/or the switching element 265) may be closed while the PCB 203 is coupled between the radio 142 (FIG. 1B) and the arrays 120 (FIG. 2A). After closing the switching element 235 (and/or the switching element 265), another switching element 235 (and/or another switching element 265) that is short-circuiting another stub ST on the PCB 203 to ground GND may be opened (Block 330). The opening and closing of switching elements 235 and/or 265 in operations shown in FIGS. 3A-3C may be performed under the control of the control circuit 204 (FIG. 2A).

After opening the other switching element 235 (and/or the other switching element 265), RF signals can be directed (Block 340) from the radio 142 to the multi-sector base station antenna 100 (FIG. 1B) via the feed network 150 (FIG. 2A). For example, RF signals can be directed (i) to all three arrays 120-1 through 120-3 using the omnidirectional configuration shown in FIG. 2C, (ii) to the first and third arrays 120-1 and 120-3 (but not the second array 120-2) in the two-sector configuration shown in FIG. 2D, or (iii) to only the first array 120-1 in the single-sector configuration shown in FIG. 2E.

FIG. 3B is a modification of FIG. 3A that specifies opening and closing switching elements 235 (FIG. 2C) of the impedance-matching portion 201 (FIG. 2A) of the feed network 150 (FIG. 2A), and further specifies directing RF signals to at least three sectors of the antenna 100. In FIG. 3B, Blocks 320′, 330′, and 340′ provide additional detail to Blocks 320, 330, and 340, respectively, of FIG. 3A.

Referring to Block 320′ of FIG. 3B, the stub ST that is short-circuited to ground GND in Block 320 (FIG. 3A) may be the first stub ST-1 (FIG. 2C) of the impedance-matching portion 201 of the feed network 150. Moreover, the short-circuiting of the first stub ST-1 may be performed by closing the first switching element 235-1 (FIG. 2C) in response to selecting (Block 310) an omnidirectional mode of the antenna 100. The mode selection may be performed by, for example, the control circuit 204.

After closing the first switching element 235-1, another switching element 235 (FIG. 2C) that is short-circuiting another stub ST of the impedance-matching portion 201 to ground GND may be opened (Block 330′). For example, the switching element 235 that is opened may be the second switching element 235-2 (FIG. 2C) if the antenna 100 is transitioning from a two-sector mode (FIG. 2D) to the omnidirectional mode, or the third switching element 235-3 (FIG. 2C) if the antenna 100 is transitioning from a single-sector mode (FIG. 2E) to the omnidirectional mode.

The transition to the omnidirectional mode also involves short-circuiting (Block 335) a stub ST of the array-selection portion 202 (FIG. 2A) of the feed network 150 to ground GND. As an example, the second switching element 265-2 (FIG. 2D) may short-circuit the fifth stub ST-5 (FIG. 2C) to ground GND if the antenna 100 is transitioning from the two-sector mode, or the third switching element 265-3 (FIG. 2E) may short-circuit the sixth stub ST-6 (FIG. 2C) to ground GND if the antenna 100 is transitioning from the single-sector mode. For simplicity of illustration, Block 335 is provided after Blocks 320′ and 330′. In some embodiments, however, the operation(s) of Block 335 may occur before Block 320′ (and in response to Block 310).

FIG. 3B also shows that RF signals may be directed (Block 340′) from the radio 142 to all sectors of the antenna 100 (via the feed network 150), which is a tri-sector antenna, while in the omnidirectional mode. Moreover, if an antenna having additional sectors (e.g., a total of four sectors) is used instead of the tri-sector antenna, then RF signals can be directed to all of those sectors. Accordingly, RF signals may be directed to at least three sectors.

FIG. 3C shows an example in which the single-sector mode, or the two-sector mode, of the antenna 100 is used instead of the omnidirectional mode. Accordingly, FIG. 3C is a modification of FIG. 3B that specifies the single-sector mode or the two-sector mode, and that further specifies disconnecting a stub ST of the array-selection portion 202 from ground GND.

As illustrated in FIG. 3C, short-circuiting (Block 320′) the first stub ST-1 of the impedance-matching portion 201 of the feed network 150 to ground GND may be performed in response to selecting (Block 310′) one of the single-sector mode or the two-sector mode of the antenna 100. Then, another switching element 235 (FIG. 2C) that is short-circuiting another stub ST of the impedance-matching portion 201 to ground GND may be opened (Block 330′). Moreover, a stub ST of the array-selection portion 202 of the feed network 150 that is coupled to ground GND during the omnidirectional mode (or during the other one of the single-sector mode or the two-sector mode) may be disconnected (Block 336) from ground GND in response to the selection of the single-sector mode or the two-sector mode.

As an example of disconnecting a stub ST of the array-selection portion 202, the fifth stub ST-5 may be disconnected from ground GND (by opening the second switching element 265-2) to transition from the omnidirectional mode to the two-sector mode. In another example, the fifth and sixth stubs ST-5 and ST-6 may be disconnected from ground GND (by opening the second and third switching elements 265-2 and 265-3) to transition from the omnidirectional mode to the single-sector mode. As a further example, the sixth stub ST-6 may be disconnected from ground GND (by opening the third switching element 265-3) to transition from the two-sector mode to the single-sector mode.

For simplicity of illustration, Block 336 is provided after Blocks 320′ and 330′. In some embodiments, however, the operation(s) of Block 336 may occur before Block 320′ (and in response to Block 310′). Moreover, to transition from the single-sector mode to the two-sector mode, the operation(s) of Block 335 (FIG. 3B) may be used instead of the operation(s) of Block 336. As an example, the sixth stub ST-6 may be short-circuited to ground GND (by closing the third switching element 265-3).

FIG. 3C also shows that RF signals may be directed (Block 340″) from the radio 142 to a single sector or two sectors of the antenna 100 (via the feed network 150), depending on whether the single-sector mode or the two-sector mode is selected. Accordingly, RF signals may be selectively directed to some (but not all) sectors when not using the omnidirectional mode.

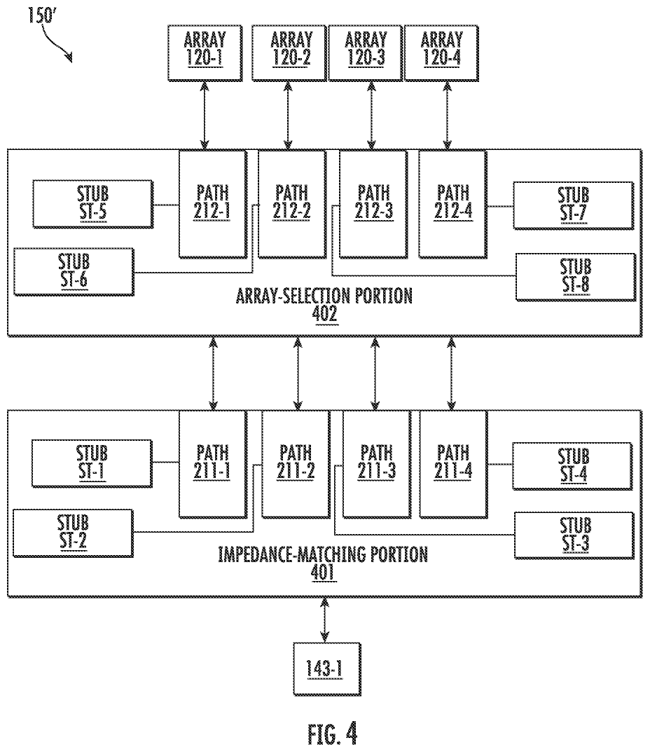

FIG. 4 is a schematic block diagram of a feed network 150′ of a four-sector base station antenna, according to further embodiments of the present invention. As shown in FIG. 4, the feed network 150′ includes an impedance-matching portion 401 and an array-selection portion 402. The impedance-matching portion 401 includes four RF paths 211-1 through 211-4 on a PCB 203 (FIG. 2B) that are coupled to four stubs ST-1 through ST-4, respectively, on the PCB 203. The array-selection portion 402 includes four RF paths 212-1 through 212-4 on the PCB 203 that are coupled to four stubs ST-5 through ST-8, respectively, on the PCB 203. Accordingly, the impedance-matching portion 401 has one more path 211 (coupled to a stub ST) than the impedance-matching portion 201 (FIG. 2A) of the feed network 150 (FIG. 2A) of the tri-sector antenna 100 (FIG. 1B). Likewise, the array-selection portion 402 has one more path 212 (coupled to a stub ST) than the array-selection portion 202 (FIG. 2A) of the feed network 150.

The four paths 212-1 through 212-4 of the array-selection portion 402 are coupled to four arrays 120-1 through 120-4, respectively, of radiating elements RE (FIG. 1A). Moreover, each array 120 may be on a respective face of a four-sided (e.g., rectangular) reflector assembly. Using an omnidirectional mode of the four-sector antenna thus includes short-circuiting all four of the stubs ST-5 through ST-8 to ground GND (and thereby directing RF signals to all four arrays 120-1 through 120-4 via the four paths 212-1 through 212-4, respectively). Each stub ST of the feed network 150′ may have an electrical length of one-quarter of a wavelength of an operating frequency of the arrays 120.

For simplicity of illustration, switching elements 235 and 265 (FIG. 2A), as well as a control circuit 204 (FIG. 2A) coupled thereto, are omitted from view in FIG. 4. The paths 211 and 212 of FIG. 4, however, may each be switchably coupled to ground GND (FIG. 2A) by a respective switching element 235 (or a respective switching element 265) that is controlled by the control circuit 204. Moreover, each path 211 of FIG. 4 may have a first portion PI (FIG. 2B) and a second portion P2 (FIG. 2B), where respective impedances of the second portions P2 of the paths 211 may differ from each other. For example, the second portion P2 of the first path 211-1 may have an impedance of 25 ohms, the second portion P2 of the second path 211-2 may have an impedance of 28.8 ohms, the second portion P2 of the third path 211-3 may have an impedance of 35.3 ohms, and the second portion P2 of the fourth path 211-4 may have an impedance of 50 ohms.

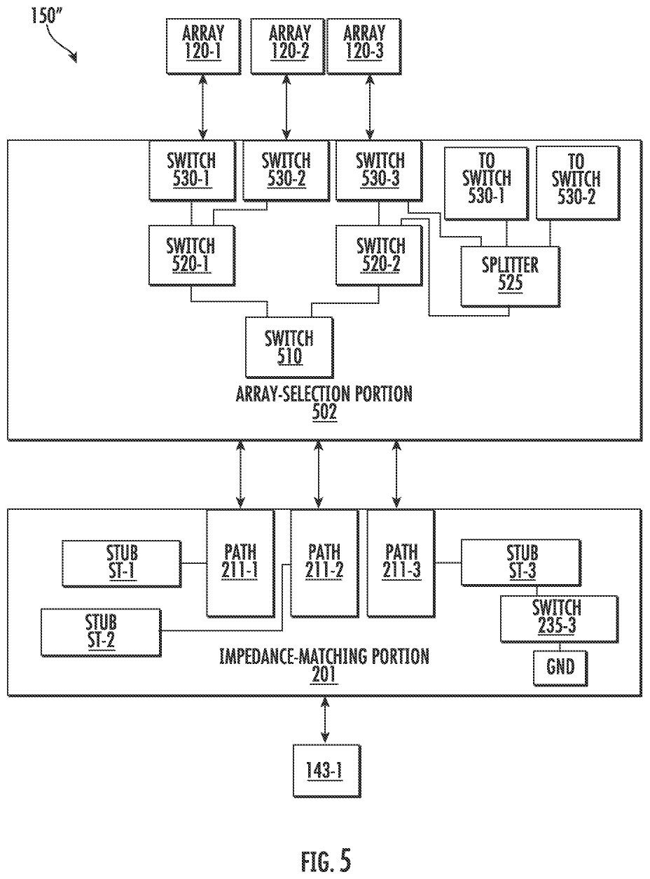

FIG. 5 is a schematic block diagram of a feed network 150″ having an array-selection portion 502 that includes tiers of RF switching elements that do not couple a PCB stub to ground, according to other embodiments of the present invention. For example, the array-selection portion 502 may be implemented with the tri-sector antenna 100 (FIG. 1B) instead of using the array-selection portion 202 (FIG. 2A) that comprises stubs ST (FIG. 2A) with the antenna 100. The tiers of RF switching elements may include (i) a first tier comprising a single switching element 510, (ii) a second tier comprising two switching elements 520-1 and 520-2 that are each coupled to the single switching element 510, and (iii) a third tier comprising three switching elements 530-1 through 530-3 that are coupled between the three arrays 120-1 through 120-3, respectively, and the two switching elements 520-1 and 520-2.

The single switching element 510 of the first tier may receive an RF output from the impedance-matching portion 201 and then provide the RF output to one of the two switching elements 520-1 and 520-2. The switching element 520-1 then provides the RF output to the switching element 530-1 or the switching element 530-2, or the switching element 520-2 then provides the RF output to the switching element 530-3 or a three-way splitter 525 that is coupled to all three switching elements 530-1 through 530-3. Accordingly, the splitter 525 can be used in an omnidirectional mode of the antenna 100.

Each of the switching elements 510, 520, and 530 may comprise a respective mechanical or solid-state relay, such as a micromechanical relay or a PIN diode switch. In some embodiments, the array-selection portion 502 may include additional switching elements beyond those that are shown in FIG. 5. For example, additional switching elements in the array-selection portion 502 may provide more controllability, such as by enabling selection of any combination of (e.g., any two of) the arrays 120-1 through 120-3. As another example, a four-sector base station antenna may be implemented by using additional switching elements in the array-selection portion 502 to select one or more of four arrays 120-1 through 120-4 (FIG. 4). Moreover, for simplicity of illustration, a control circuit 204 (FIG. 2A) that controls the switching elements 235 of the impedance-matching portion 201 and the switching elements 510, 520, and 530 of the array-selection portion 502 is omitted from view in FIG. 5.

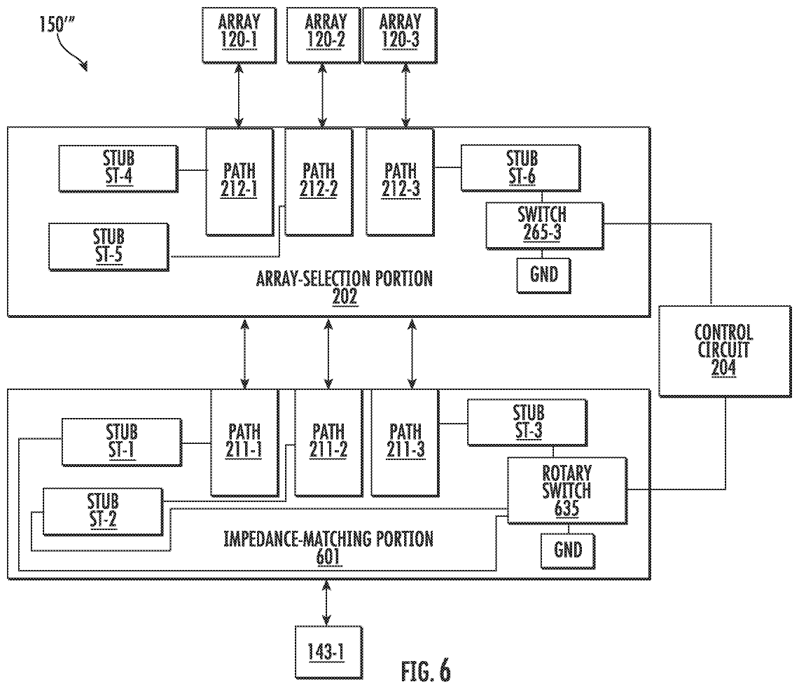

FIG. 6 is a schematic block diagram of a feed network 150″ having an impedance-matching portion 601 that includes a rotary switch 635, according to further embodiments of the present invention. Each of the three stubs ST-1 through ST-3 of the impedance-matching portion 601 is switchably coupled to ground GND by the same (i.e., a single) rotary switch 635. In contrast, the three switching elements 265-1 through 265-3 (FIGS. 2C-2E) of the array-selection portion 202 switchably couple the three stubs ST-4 through ST-6, respectively, to ground GND and may comprise mechanical or solid-state relays that are not rotary switches. In some embodiments, the rotary switch 635 and the switching elements 265 may all be under the control of a control circuit 204.

RF feed networks 150, 150′, 150″, 150′ (FIGS. 2A and 4-6) according to embodiments of the present invention may provide a number of advantages. These advantages include reducing feed-network complexity and RF losses by using stubs ST (FIG. 2A) that are switchably coupled to ground GND. For example, an impedance-matching portion 201 (FIG. 2A) of the feed network 150 may include a plurality of RF paths 211 (FIG. 2A) on a PCB 203 (FIG. 2B) that have a plurality of different impedances, respectively, and that are coupled to a plurality of stubs ST, respectively, on the PCB 203 that are each switchably coupled to ground GND. Each stub ST may have an electrical length of one-quarter of a wavelength of an operating frequency of arrays 120 (FIG. 2A) of radiating elements RE (FIG. 1A) that are fed by the feed network 150, and may help to reduce RF losses. Moreover, by implementing stubs ST in the impedance-matching portion 201 and/or in an array-selection portion 202 (FIG. 2A) of the feed network 150, fewer switching elements 235/265 (e.g., one per path 211 and/or one per path 212 (FIG. 2A)) can be used than in a tiered arrangement of switching elements (e.g., a switching tree). The smaller number of switching elements 235/265 can reduce both RF losses and circuit complexity of the feed network 150.

In some embodiments, the feed network 150 may exhibit a return loss of less than about −10 decibels (“dB”) at all times (i.e., more than 90% of the RF energy input to the feed network 150 will be output through the selected arrays 120).

According to some embodiments, the feed networks 150, 150′, 150″, 150′ can be implemented to reconfigure radiation patterns of multi-sector antennas (e.g., small-cell antennas) and/or to efficiently achieve RF power sharing between sectors of multi-sector antennas. Moreover, though the feed network 150 is shown as being coupled to a four-port radio 142 (FIG. 1B), this is merely one example, and the feed networks 150, 150′, 150″, 150″ can be expanded (e.g., by adding switching elements 235/265, paths 211/212, and stubs ST) for implementation with any number of RF ports.

The present invention has been described above with reference to the accompanying drawings. The present invention is not limited to the illustrated embodiments. Rather, these embodiments are intended to fully and completely disclose the present invention to those skilled in this art. In the drawings, like numbers refer to like elements throughout. Thicknesses and dimensions of some components may be exaggerated for clarity.

Spatially relative terms, such as “under,” “below,” “lower,” “over,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the example term “under” can encompass both an orientation of over and under. The device may be otherwise oriented (rotated 90 degrees or at other orientations) and the spatially relative descriptors used herein interpreted accordingly.

Herein, the terms “attached,” “connected,” “interconnected,” “contacting,” “mounted,” “coupled,” and the like can mean either direct or indirect attachment or coupling between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and/or “including” when used in this specification, specify the presence of stated features, operations, elements, and/or components, but do not preclude the presence or addition of one or more other features, operations, elements, components, and/or groups thereof.

1. A base station antenna comprising:
a plurality of arrays of radiating elements; and
a radio frequency (RF) feed network that has a plurality of impedance-matching paths that have different impedances, respectively, and are selectively coupled between the arrays and an input of the RF feed network.

2. The base station antenna of claim 1, wherein the impedance-matching paths are coupled to a plurality of RF transmission lines, respectively, that are switchably coupled to ground by a plurality of switching elements, respectively, and that each have an electrical length of one-quarter of a wavelength corresponding to a center frequency of an operating frequency band of the arrays.

3. The base station antenna of claim 2, wherein the RF transmission lines are respective stubs on a printed circuit board (PCB).

4. The base station antenna of claim 3,
wherein a first of the impedance-matching paths comprises a first portion having a first line width on the PCB and a second portion having a second line width on the PCB that is different from the first line width, and
wherein a first of the stubs is coupled to a node between the first and second portions of the first of the impedance-matching paths.

5. The base station antenna of claim 4, wherein the second portion of the first of the impedance-matching paths has a lower impedance than the first portion of the first of the impedance-matching paths, and is coupled between the arrays and the first portion of the first of the impedance-matching paths.

6. The base station antenna of claim 3, further comprising a control circuit that is configured to select between the impedance-matching paths,
wherein selecting between the impedance-matching paths comprises selecting a first of the impedance-matching paths by closing a first of the switching elements and thereby short-circuiting to ground a first of the stubs that is coupled to the first of the impedance-matching paths.

7. The base station antenna of claim 6, wherein the control circuit is configured to close the first of the switching elements before opening a second of the switching elements that is short-circuiting to ground a second of the stubs that is coupled to a second of the impedance-matching paths.

8. The base station antenna of claim 1, further comprising a triangular reflector that has a plurality of faces that face in different directions, respectively, and the arrays of radiating elements are on the respective faces of the reflector, and wherein the impedance-matching paths comprise three impedance-matching paths.

9. The base station antenna of claim 1, wherein the base station antenna is configured to provide omnidirectional coverage in the azimuth plane.

10. The base station antenna of claim 1,
wherein the input of the RF feed network is a first input, and
wherein the base station antenna is in combination with a radio that includes:
first and second first-polarization RF ports that are coupled to the first input and a second input, respectively, of the RF feed network; and
first and second second-polarization RF ports that are coupled to third and fourth inputs, respectively, of the RF feed network.

11. The base station antenna of claim 1, wherein the arrays comprise six arrays of radiating elements, with three of the arrays coupled to the first and second ports of a radio, and the other three of the arrays coupled to third and fourth ports of the radio.

12. The base station antenna of claim 1,
wherein the RF feed network further comprises a plurality of array-selection paths that are coupled between the arrays and the impedance-matching paths, and
wherein the array-selection paths are coupled to a plurality of RF transmission lines, respectively, that are switchably coupled to ground by a plurality of switching elements, respectively, and that each have an electrical length of one-quarter of a wavelength of an operating frequency of the arrays.

13. The base station antenna of claim 12,
wherein the RF transmission lines are respective stubs on a printed circuit board (PCB), and
wherein the base station antenna further comprises a control circuit that is configured to short-circuit a first of the stubs to ground by closing a first of the switching elements, before opening a second of the switching elements that is short-circuiting a second of the stubs to ground.

14-20. (canceled)

21. A base station antenna comprising:
a radio frequency (“RF”) port;
a plurality of arrays of radiating elements that are coupled to the RF port; and
an RF feed network that is coupled between the RF port and the arrays, the RF feed network comprising:
an impedance-matching portion including at least three impedance-matching paths that have different impedances, respectively, and are coupled between the arrays and the RF port; and
an array-selection portion including at least three paths that are coupled between the arrays and the impedance-matching portion.

22. The base station antenna of claim 21, wherein the impedance-matching portion further includes a plurality of stubs on a printed circuit board (PCB) that are coupled to the impedance-matching paths, respectively.

23. The base station antenna of claim 22, further comprising a plurality of switching elements that are coupled between the stubs, respectively, and ground.

24. The base station antenna of claim 22, further comprising a single rotary switch that is coupled between all of the stubs and ground.

25. The base station antenna of claim 22, wherein the stubs each have an electrical length of one-quarter of a wavelength of an operating frequency of the arrays.

26. The base station antenna of claim 22,
wherein a first of the impedance-matching paths comprises a first portion having a first line width on the PCB and a second portion having a second line width on the PCB that is wider than the first line width, and
wherein a first of the stubs is coupled to a node between the first and second portions of the first of the impedance-matching paths.

27. The base station antenna of claim 21, wherein the array-selection portion further includes a plurality of stubs on a printed circuit board (PCB) that are coupled to the at least three paths, respectively.

28-29. (canceled)
